(19) United States
(12) Patent Application Publication
(10) Pub. No.: US 2020/0184970 A1
(43) Pub. Date: Jun. 11, 2020

(54) VOICE OPERATION SYSTEM, VOICE OPERATION METHOD, AND VOICE OPERATION PROGRAM

(71) Applicant: KONICA MINOLTA, INC., Chiyoda-ku (JP)

(72) Inventor: Takuya KAWANO, Toyokawa-shi (JP)

(73) Assignee: KONICA MINOLTA, INC., Chiyoda-ku (JP)

(21) Appl. No.: 16/675,444

(22) Filed: Nov. 6, 2019

(30) Foreign Application Priority Data
Dec. 7, 2018 (JP) 2018-230042

(51) Int. Cl. G10L 15/22; G10L 15/30; H04N 1/00

(52) U.S. Cl. CPC G10L 15/22; G10L 15/30; G10L 2015/223; H04N 1/00244; H04N 1/00403

(57) ABSTRACT

A voice operation system includes: a processing device; and a receiver that receives a user's voice instruction given to the processing device, wherein the receiver includes: a voice recognizer that performs voice recognition of the voice instruction; and a notifier that, when the voice recognizer has partially failed in voice recognition of a portion of the voice instruction, notifies the processing device of an operation command corresponding to the portion of the voice instruction for which voice recognition has been successful, and the processing device includes a processor that performs processing corresponding to a command content of the operation command.

The entire disclosure of Japanese patent Application No. 2018-230042, filed on Dec. 7, 2018, is incorporated herein by reference in its entirety.

### BACKGROUND

### Technological Field

The present invention relates to a voice operation system, a voice operation method, and a voice operation program and more particularly to a technology that can suppress the start delay of device operation when a voice instruction needs to be given again.

### Description of the Related Art

Recently, technologies using virtual assistant servers via smart speakers to give voice instructions to devices for achieving various tasks or services have been put into practical use. In the technical field of image forming apparatuses as well, it has been studied to operate the apparatuses by using such a voice interface.

For this reason, for example, a technology of generating text data from a voice instruction by using voice recognition technology, recognizing a sentence being a combination of nouns, post particles, verbs included in the obtained text data, and operating an image forming apparatus is proposed (see JP 2011-65108 A). With the technology, a voice instruction is not restricted by the order of words and can be given in any order, improving the user's convenience.

The related art described above is premised on voice recognition of words. When the voice recognition fails to recognize any word, the user may not be able to instruct the image forming apparatus to perform an operation as intended by the user. In such a case, if a smart speaker is used to notify the user of the failure in voice recognition and prompt the user to input the voice instruction again, improved accuracy in the contents of operation for the image forming apparatus can be provided.

However, the repeated user's voice instruction leads to a delay in starting a job to be performed by the image forming apparatus by the length of time used in the repeating. For example, as illustrated in FIG. 28, when the user gives a voice instruction to a smart speaker (SS) to say “Please make a print”, a print command is promptly given to an image forming apparatus unless a virtual assistant server fails in voice recognition. Therefore, as illustrated in FIG. 28, an image forming process is started promptly after the image forming apparatus is warmed up.

On the other hand, when the voice recognition fails to recognize a user's instruction, the smart speaker is used to request the user to give a repeated instruction, for example, “Please repeat your instruction” and receive a repeated voice instruction “Please make a print”, from the user, in response to the repeated request. If the voice recognition successfully recognizes the repeated instruction, the virtual assistant server issues the print command to the image forming apparatus, and the image forming apparatus starts the image forming process according to the print command.

For this reason, when the user is requested to give a repeated instruction due to failure in the voice recognition for recognizing the user's instruction, the start of the image forming process performed by the image forming apparatus is delayed. In addition, if the user speaks an instruction slowly for successful voice recognition, a further long time is required.

### SUMMARY

The present invention has been made in view of the above-described problems, and an object of the present invention is to provide a voice operation system, a voice operation method, and a voice operation method that can suppress a delay in starting a job when voice recognition fails to recognize a user's instruction.

To achieve the abovementioned object, according to an aspect of the present invention, a voice operation system reflecting one aspect of the present invention comprises: a processing device; and a receiver that receives a user's voice instruction given to the processing device, wherein the receiver includes: a voice recognizer that performs voice recognition of the voice instruction; and a notifier that, when the voice recognizer has partially failed in voice recognition of a portion of the voice instruction, notifies the processing device of an operation command corresponding to the portion of the voice instruction for which voice recognition has been successful, and the processing device includes a processor that performs processing corresponding to a command content of the operation command.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a main configuration of an image forming system according to an embodiment of the present invention;

FIG. 2 is a sequence diagram illustrating a process performed when voice recognition processing is successful for a user's instruction;

FIG. 3 is a sequence diagram illustrating a process performed when voice recognition processing has partially failed to recognize a user's instruction;

FIG. 4 is a block diagram illustrating a main hardware configuration of a smart speaker;

FIG. 5 is a block diagram illustrating a main hardware configuration of a virtual assistant server;

FIG. 6 is a block diagram illustrating a main functional configuration of the virtual assistant server;

FIG. 7 is a diagram illustrating an example of an operation target specification table;

FIG. 8 is a flowchart illustrating a main routine of the virtual assistant server;

FIG. 9 is a flowchart illustrating pre-operation command processing by the virtual assistant server;

FIG. 10 is a flowchart illustrating repeated instruction request processing by the virtual assistant server;

FIG. 11 is a flowchart illustrating additional operation command processing by the virtual assistant server;

FIG. 12 is a flowchart illustrating normal operation command processing by the virtual assistant server;

FIG. 13 is a diagram illustrating a main configuration of a multi-function peripheral;

FIG. 14 is a block diagram illustrating a main hardware configuration of the multi-function peripheral;

FIG. 15 is a block diagram illustrating a main functional configuration of the multi-function peripheral;

FIG. 16 is a diagram illustrating an example of a pre-processing table;

FIG. 17 is a flowchart illustrating a main routine of the multi-function peripheral;

FIG. 18 is a flowchart illustrating pre-processing by the multi-function peripheral;

FIG. 19 is a flowchart illustrating main processing by the multi-function peripheral;

FIG. 20 is a flowchart illustrating normal processing by the multi-function peripheral;

FIG. 21 is a block diagram illustrating a main hardware configuration of a mobile terminal device;

FIG. 22 is a block diagram illustrating a main functional configuration of the mobile terminal device;

FIG. 23 is a diagram illustrating a pre-processing table;

FIG. 24 is a flowchart illustrating a main routine of the mobile terminal device;

FIG. 25 is a flowchart illustrating pre-processing by the mobile terminal device;

FIG. 26 is a flowchart illustrating main processing by the mobile terminal device;

FIG. 27 is a flowchart illustrating normal processing by the mobile terminal device; and

FIG. 28 is a diagram illustrating voice operation according to a related art.

### DETAILED DESCRIPTION OF EMBODIMENTS

Hereinafter, one or more embodiments of a voice operation system, a voice operation method, and a voice operation program according to the present invention will be described with reference to the drawings, taking an image forming system as an example. However, the scope of the invention is not limited to the disclosed embodiments.

### [1] Configuration of Image Forming System

Firstly, the configuration of the image forming system according to the present embodiment will be described.

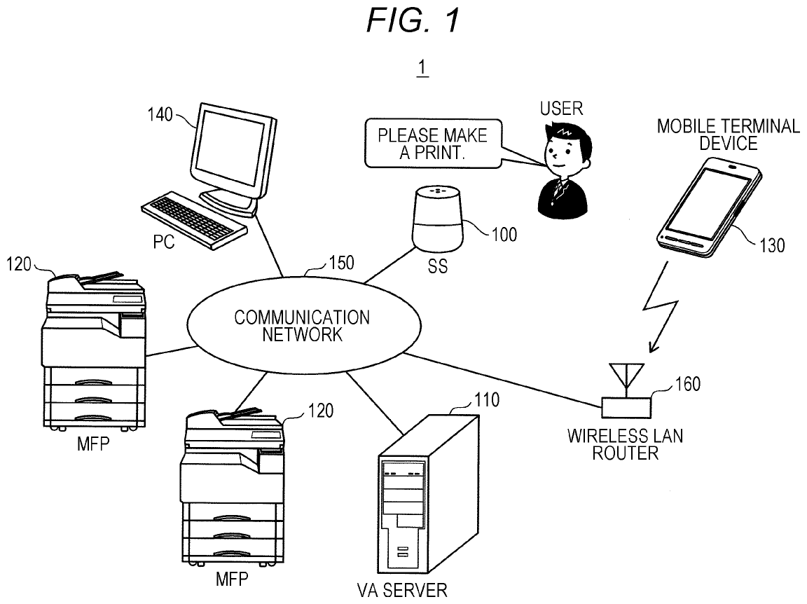

As illustrated in FIG. 1, the image forming system 1 includes a smart speaker (SS) 100, a virtual assistant (VA) server 110, multi-function peripherals (MFP) 120, and the like which are communicably connected by using a communication network 150. The communication network 150 includes the so-called Internet and a local area network (LAN).

When receiving a user's voice instruction from a user of the image forming system 1, the smart speaker 100 generates voice data and transmits the voice data to the virtual assistant server 110. Furthermore, when receiving the voice data from the virtual assistant server 110, the smart speaker 100 outputs the voice data by voice.

When receiving the voice data of the user's instruction from the smart speaker 100, the virtual assistant server 110 converts the voice data into text data by voice recognition processing and analyzes the text data to cause the multi-function peripheral 120 to perform processing according to the content of the user's instruction. When the voice recognition processing fails, the virtual assistant server 110 generates text data requesting the user to issue a repeated instruction and synthesize voice data from the text data by voice synthesis processing to transmit the voice data to the smart speaker 100.

Each of the multi-function peripherals 120 has functions, such as a printer function, a scanner function, a copy function, and a facsimile function and executes a job received from the virtual assistant server 110, the mobile terminal device 130, the personal computer (PC) 140, or the like. Furthermore, the multi-function peripheral 120 includes an operation panel and also executes a job received from the operation panel.

The mobile terminal device 130 has a function of causing the user to create electronic data used for image formation, and a function of transmitting a print job including the created electronic data to the multi-function peripheral 120. When the print job is transmitted, a printer driver is activated. The mobile terminal device 130 is wirelessly connected to a wireless LAN router 160 to transmit a print job to the multi-function peripheral 120 via the communication network 150.

As in the mobile terminal device 130, the personal computer 140 has a function of causing the user to create electronic data used for image formation, and a function of transmitting a print job including the created electronic data to the multi-function peripheral 120. When transmitting the print job, the printer driver is activated, and the print job is transmitted to the multi-function peripheral 120 via the communication network 150.

### [2] Operation of Image Forming System 1

Next, the operation of the image forming system 1 will be described.

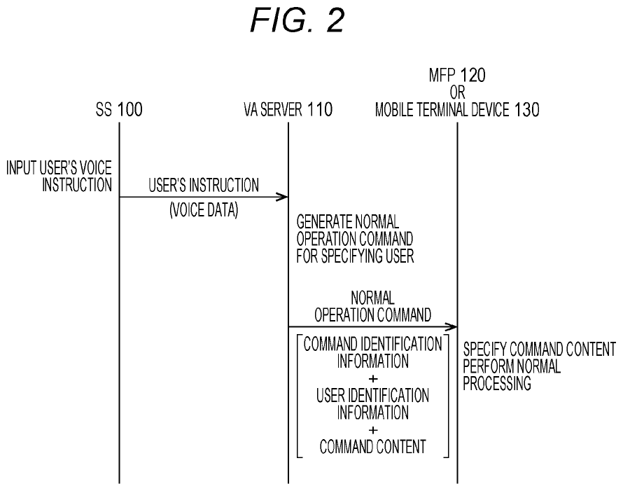

As illustrated in FIG. 2, when the user of the image forming system 1 inputs a user's instruction by voice to the smart speaker 100, the smart speaker 100 generates voice data of the user's instruction and transmits the voice data to the virtual assistant server 110.

When the virtual assistant server 110 receives the voice data of the user's instruction from the smart speaker 100, the virtual assistant server 110 specifies the user from the voice data by speaking-person identification processing and generates user identification information. Furthermore, the virtual assistant server 110 generates text data from the voice data of the user's instruction through voice recognition processing and specifies an operation target and command content relating to the user's instruction from the text data through natural language processing.

When the operation target is a multi-function peripheral 120 and there are a plurality of multi-function peripherals 120, the position of the smart speaker 100 is specified, and the multi-function peripheral 120 closest to the smart speaker 100 is set as the operation target.

The virtual assistant server 110 creates a normal operation command including user identification information, a command content, and command identification information indicating that the command is a normal operation command and transmits the normal operation command to the operation target. The operation target is, for example, the multi-function peripheral 120 or the mobile terminal device 130.

The multi-function peripheral 120 or mobile terminal device 130 as the operation target executes user authentication by using the user identification information when receiving the normal operation command, and executes the command with reference to the command content when the user authentication is successful.

However, the voice recognition processing for generating text data from voice data of a user's instruction may partially fail.

For example, when a user's instruction is given to the smart speaker 100 in so-called spoken language, the spoken language having a reduction of articulation causing ambiguous acoustic characteristics in voice may cause a partial failure in voice recognition processing due to confusion of phonemes in voice recognition processing. Furthermore, voice recognition processing may fail when there is insertion of a word called a filler, such as “Uh” or “Well”, omission of a particle in Japanese grammar, such as “-WA” or “-GA”, and further a variation in way of saying in spoken Japanese language, such as “oo-TTEIU”. Needless to say, the failure in the voice recognition processing may be caused by noise as well.

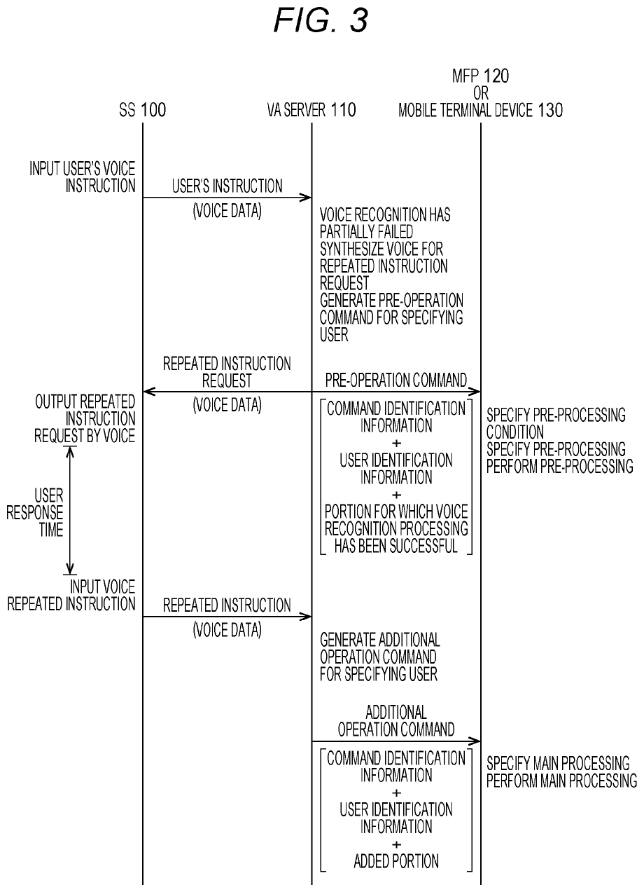

As described above, even in a case where the voice recognition processing partially fails to recognize a user's instruction, when the user of the image forming system 1 firstly inputs, by voice, the user's instruction to the smart speaker 100 as illustrated in FIG. 3, the smart speaker 100 generates voice data of the user's instruction and transmits the voice data to the virtual assistant server 110.

When the virtual assistant server 110 receives the voice data of the user's instruction from the smart speaker 100, the virtual assistant server 110 specifies the user from the voice data by speaking-person identification processing and generates user identification information.

In a case where the voice recognition processing partially fails to generate text data from voice data of a user's instruction, the virtual assistant server 110 synthesizes voice data for requesting the user to repeat the instruction and transmits the voice data to the smart speaker 100. The smart speaker 100 outputs, by voice, the voice data for requesting the repeated instruction.

Furthermore, the virtual assistant server 110 identifies the user from the voice data of the user's instruction by the speaking-person identification processing to generate the user identification information, and generates text data excluding a portion where the voice recognition processing has failed to specify, from the text data, an operation target and a command content relating to the user instruction by the natural language processing.

Then, a pre-operation command including command identification information indicating that the command is a pre-operation command, user identification information, and a command content of a portion for which voice recognition processing is successful is transmitted to the operation target relating to the user's instruction.

The multi-function peripheral 120 or the mobile terminal device 130 which receives the pre-operation command performs user authentication by using the user identification information, and when the user authentication is successful, the command content included in the pre-operation command is referred to, pre-processing corresponding to the command content is specified, and the specified pre-processing is performed.

Thereafter, when receiving the repeated instruction from the user, the smart speaker 100 generates voice data of the repeated instruction, and transmits the voice data to the virtual assistant server 110.

The virtual assistant server 110 receiving the voice data of the repeated instruction specifies a user from the voice data of the repeated instruction by the speaking-person identification processing and generates user identification information. Furthermore, the virtual assistant server 110 generates text data of the repeated instruction by voice recognition processing and specifies an operation target and a command content relating to the repeated instruction, from the text data by the natural language processing.

Then, the virtual assistant server 110 transmits an additional operation command including a command identification information indicating that the command is an additional operation command, the user identification information and the command content relating to the repeated instruction, to the operation target relating to the repeated instruction.

The multi-function peripheral 120 or the mobile terminal device 130 which receives the additional operation command performs user authentication by using the user identification information, and when the user authentication is successful, the command content included in the additional operation command and the command content included in the pre-operation command previously received are referred to, a main processing corresponding to these command contents is specified, and the specified main processing is performed.

### [3] Configuration of Smart Speaker 100

Next, the configuration of the smart speaker 100 will be described.

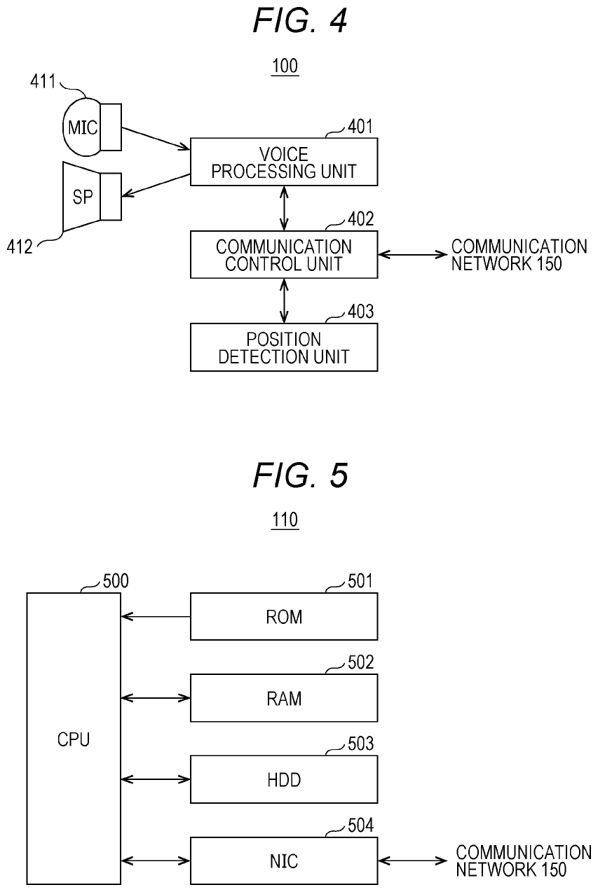

As illustrated in FIG. 4, the smart speaker 100 includes a voice processing unit 401, a communication control unit 402, and a position detection unit 403, and further, a microphone 411 and a speaker 412 are connected to the voice processing unit 401.

The voice processing unit 401 performs analogue to digital (AD) conversion for an analog audio signal collected by using the microphone 411, generates voice data obtained by compression encoding, and restores an analog voice signal from voice data received from the communication control unit 402, causing the speaker 412 to output voice. The communication control unit 402 performs communication processing for transmitting and receiving voice data and the like to and from the virtual assistant server 110 via the communication network 150.

The position detection unit 403 uses a global positioning system (GPS) to detect the current position of the smart speaker 100 and transmits position information together with the voice data transmitted to the virtual assistant server 110.

### [4] Configuration and Operation of Virtual Assistant Server 110

Next, the configuration and operation of the virtual assistant server 110 will be described.

### (4-1) Configuration of Virtual Assistant Server 110

As illustrated in FIG. 5, the virtual assistant server 110 includes a central processing unit (CPU) 500, a read only memory (ROM) 501, a random access memory (RAM) 502, and the like, and the virtual assistant server 110 reads an operating system (OS) and other programs from a hard disk drive (HDD) 503 and executes the OS and the programs with the RAM 502 as a working storage area.

A network interface card (NIC) 504 performs communication processing for interconnecting the smart speaker 100, the multi-function peripherals 120, the mobile terminal device 130, and the PC 140 via the communication network 150. The ROM 501 stores a boot program, and the CPU 500 reads and starts the boot program after resetting.

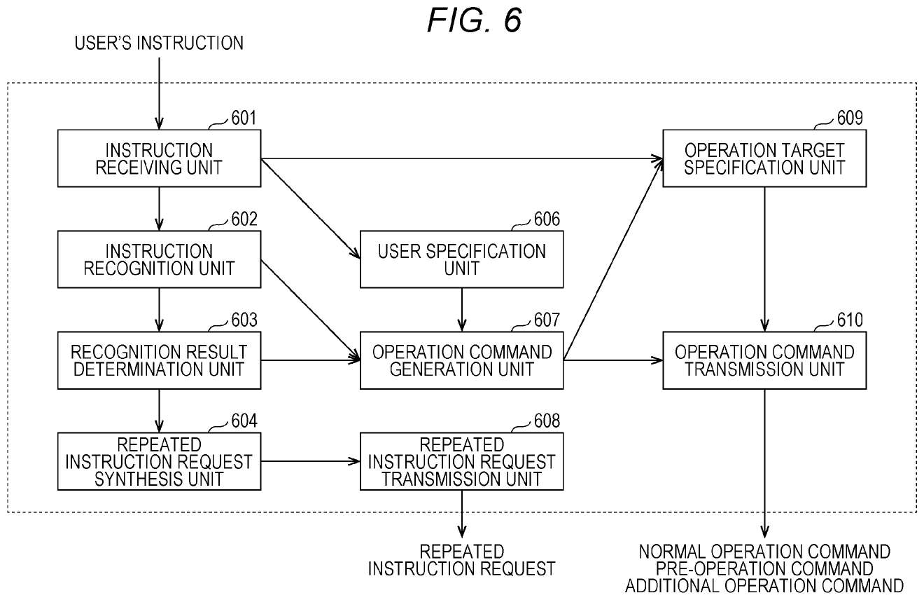

FIG. 6 is a block diagram illustrating a functional configuration of the virtual assistant server 110. As illustrated in FIG. 6, the virtual assistant server 110 receives, at an instruction receiving unit 601, from the smart speaker 100, voice data of a user's instruction and a repeated instruction and the position information about the smart speaker 100.

An instruction recognition unit 602 generates text data from voice data of a user's instruction and a repeated instruction by voice recognition processing. In the present embodiment, a noise level of voice data is reduced by using a noise reduction algorithm, and then, three probability models, that is, an acoustic model P(X|S) obtained by modeling the voice data for each phoneme by using the frequency characteristics of the voice data, a pronunciation dictionary P(S|W) in which phonemes constituting words are defined, for the respective words, and a language model P(W) in which easiness of connection of words is defined, are multiplied together to obtain a string W of words having the maximum product P(X|S)·P(S|W)·P(W), and the text data is generated.

A recognition result determination unit 603 determines whether voice recognition processing has partially failed to recognize a user's instruction. For example, as described above, when the reduction of articulation is caused in pronunciation of the spoken language, ambiguous acoustic feature of the voice reduces the value of the acoustic model P(X|S) during a corresponding period in voice data. In addition, the values of the probability models also decrease due to noise. If such a decrease in the values of the probability models is detected, it can be determined that the voice recognition processing has partially failed.

When the recognition result determination unit 603 determines that the voice recognition processing has partially failed to recognize a user's instruction, a repeated instruction request synthesis unit 604 replaces a portion of voice data of a user's instruction where the voice recognition processing has failed with a warning sound (for example, beep sound may be used), adds voice data of a message requesting a repeated instruction, and synthesize voice data for requesting a repeated instruction.

For example, in a case where voice data of a user's instruction represent “Print this Word file in 2in1 mode (a portion where voice recognition processing has failed) of an A4 recycled paper using a nearby MFP”, the portion where the voice recognition processing has failed is firstly replaced with the warning sound, and voice data “Print this Word file in 2in1 mode (warning sound) of an A4 recycled paper using a nearby MFP” is synthesized. Furthermore, the voice data of a message requesting a repeated instruction “I did not catch that. Could you say that again?” is added.

Thus, voice data “I did not catch that. Could you say that again. Print this Word file in 2in1 mode (warning sound) of an A4 recycled paper using a nearby MFP” can be obtained as the voice data for requesting a repeated instruction.

A repeated instruction request transmission unit 608 transmits the voice data for requesting a repeated instruction which is synthesized by the repeated instruction request synthesis unit 604 to the smart speaker 100.

A user specification unit 606 generates user identification information from voice data of a user's instruction and a repeated instruction by text-independent speaking-person identification processing. In the speaking-person identification processing, firstly, the following method can be employed. In the method, the noise level of voice data is reduced by using the noise reduction algorithm, and then, for example, average vectors of a model speaking person expressed by a Gaussian mixture model (GMM) are connected to constitute a high-dimensional vector (GMM supervector), and then speaking person identification is performed by a support vector machine (SVM). Needless to say, the user identification information may be generated using another method.

An operation command generation unit 607 generates a normal operation command, a pre-operation command, and an additional operation command. The operation command generation unit 607 determines that an instruction received after transmitting voice data for requesting a repeated instruction to the smart speaker 100 is a repeated instruction and selects command identification information of an additional operation command. When the operation command generation unit 607 determines that the instruction is not a repeated instruction and the recognition result determination unit 603 determines that the instruction recognition unit 602 is successful in the voice recognition processing, command identification information of a normal operation command is selected. Furthermore, when the recognition result determination unit 603 determines that the instruction recognition unit 602 has partially failed in the voice recognition processing, command identification information of a pre-operation command is selected.

The operation command generation unit 607 acquires text data of a user's instruction or repeated instruction from the instruction recognition unit 602, specifies a command content of a portion for which voice recognition processing is successful, and acquires user identification information from the user specification unit 606, and generates an operation command including the command identification information, the user identification information, and the command content.

An operation target specification unit 609 acquires position information about the smart speaker 100 from the instruction receiving unit 601 and acquires a command content from the operation command generation unit 607 to specify an operation target. Therefore, the operation target specification unit 609 stores an operation target specification table for associating a combination of a command content and the position information about a multi-function peripheral 120 with an operation target, and the operation target specification unit 609 specifies an operation target according to the position of the smart speaker 100, with reference to the operation target specification table.

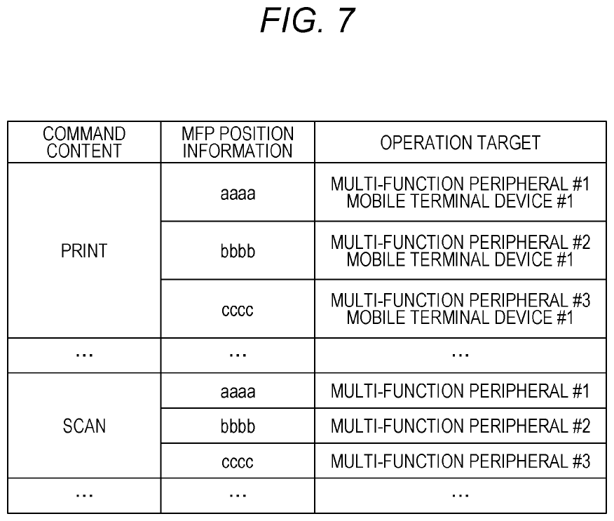

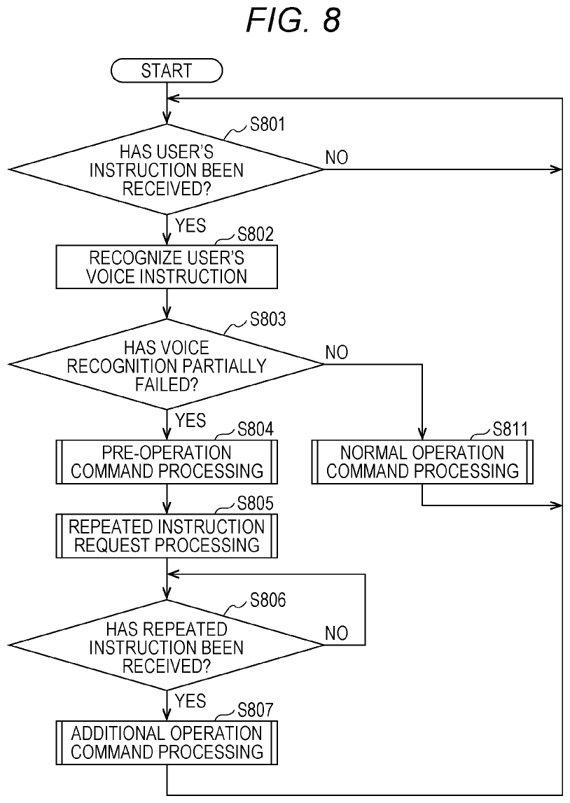

FIG. 7 is a diagram illustrating an example of the operation target specification table. As illustrated in FIG. 7, in the operation target specification table, for example, when the command content is “print” and MFP position information aaaa is closest to the smart speaker 100, an MFP #1 and a mobile terminal #1 are selected as the operation target. When the command content is “scan” and MFP position information bbbb is closest to the smart speaker 100, an MFP #2 is selected as the operation target.

In this way, a multi-function peripheral 120 arranged at a position closest to the smart speaker 100 can be set as the operation target. Since the user gives a voice instruction near the smart speaker 100, a multi-function peripheral 120 closer to the smart speaker 100 is also positioned closer to the user. If a multi-function peripheral 120 is selected and operated in such a manner, the convenience of the user can be improved.

An operation command transmission unit 610 transmits an operation command generated by the operation command generation unit 607 to the operation target specified by the operation target specification unit 609.

### (4-2) Operation of Virtual Assistant Server 110

Next, the operation of the virtual assistant server 110 will be described.

### (4-2-1) Main Routine

As illustrated in FIG. 8, in the virtual assistant server 110, when the instruction receiving unit 601 receives a user's instruction (S801: YES), the instruction recognition unit 602 generates text data from voice data of the user's instruction by voice recognition processing (S802).

When the recognition result determination unit 603 determines that the instruction recognition unit 602 has partially failed in voice recognition processing for the user's instruction (S803: YES), pre-operation command processing (S804) and repeated instruction request processing (S805) are performed sequentially Thereafter, when receiving voice data of a repeated instruction from the smart speaker 100 (S806: YES), the instruction receiving unit 601 performs additional operation command processing (S807). After completion of the additional operation command processing, the process proceeds to step S801, and the process described above is repeated.

When the recognition result determination unit 603 determines that the instruction recognition unit 602 is successful in the voice recognition processing for the user's instruction (S803: NO), after performance of the normal operation command processing (S811), the process proceeds to step S801, and the process described above is repeated.

### (4-2-2) Pre-Operation Command Processing (S804)

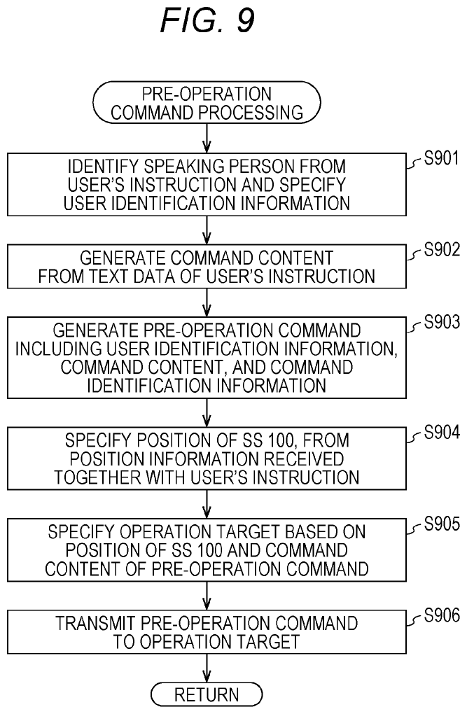

In the pre-operation command processing, as illustrated in FIG. 9, the user specification unit 606 specifies user identification information from the voice data of the user's instruction by speaking-person identification processing (S901), and the operation command generation unit 607 generates a command content from text data of the user's instruction by natural language processing (S902).

Furthermore, the operation command generation unit 607 generates a pre-operation command including command identification information indicating that the command is a pre-operation command, the user identification information, and the command content (S903).

The operation target specification unit 609 specifies the position of the smart speaker 100 from position information received by the instruction receiving unit 601 together with voice data (S904) and refers to the position information of the smart speaker 100 and the command content of the pre-operation command to specify a device being the operation target (S905). Thereafter, the operation command transmission unit 610 transmits the pre-operation command to the operation target (S906), and the process returns to the main routine.

### (4-2-3) Repeated Instruction Request Processing (S805)

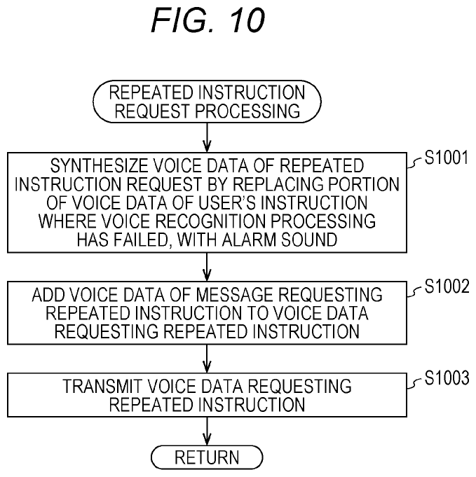

In the repeated instruction request processing, as illustrated in FIG. 10, the repeated instruction request synthesis unit 604 replaces a portion of the voice data of the user's instruction where the voice recognition processing has failed with a warning sound to synthesize voice data for requesting a repeated instruction (S1001) and adds voice data of a message requesting a repeated instruction to the voice data (S1002). After the repeated instruction request transmission unit 608 transmits the voice data for requesting a repeated instruction, which is synthesized in this way, to the smart speaker 100 (S1003), the process returns to the main routine.

### (4-2-4) Additional Operation Command Processing (S807)

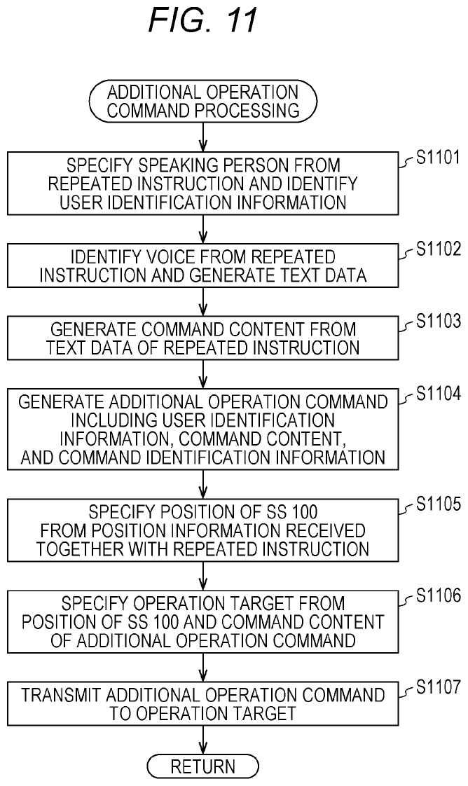

In the additional operation command processing, as illustrated in FIG. 11, the user specification unit 606 specifies user identification information from the voice data of the repeated instruction by speaking-person identification processing (S1101), the instruction recognition unit 602 generates text data from the voice data of the repeated instruction by voice recognition processing (S1102), and the operation command generation unit 607 generates a command content from the text data of the repeated instruction by natural language processing (S1103). Then, the operation command generation unit 607 generates an additional operation command including command identification information indicating that the command is an additional operation command, the user identification information, and the command content (S1104).

Next, the operation target specification unit 609 receives the position information of the smart speaker 100 from the instruction receiving unit 601 together with the repeated instruction and specifies the position of the smart speaker 100 (S1105), and specifies the operation target by using the command content of the additional operation command and the position information of the smart speaker 100 (S1106). Then, after the operation command transmission unit 610 transmits the additional operation command to the operation target (S1107), the process returns to the main routine.

### (4-2-5) Normal Operation Command Processing (S811)

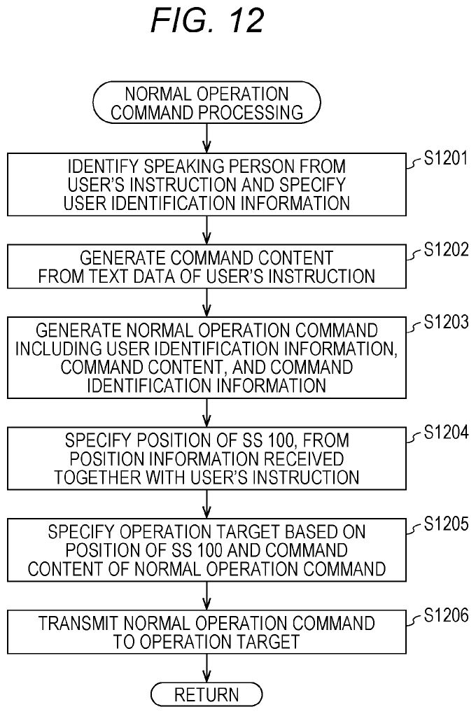

In the normal operation command processing, as illustrated in FIG. 12, the user specification unit 606 specifies user identification information from the voice data of the user's instruction by speaking-person identification processing (S1201). Next, the operation command generation unit 607 generates a command content from text data of the user's instruction by natural language processing (S1202) and generates a normal operation command including command identification information indicating that the command is a normal operation command, the user identification information, and the command content (S1203).

The operation target specification unit 609 specifies the position of the smart speaker 100 from position information received by the user's instruction receiving unit 601 together with voice data (S1204) and refers to the command content of the normal operation command to specify a device being the operation target (S1205). Thereafter, the operation command transmission unit 615 transmits the normal operation command to the operation target (S1206), and the process returns to the main routine.

### [5] Configuration and Operation of Multi-Function Peripheral 120

Next, the configuration and operation of the multi-function peripheral 120 will be described.

### (5-1) Configuration of Multi-Function Peripheral 120

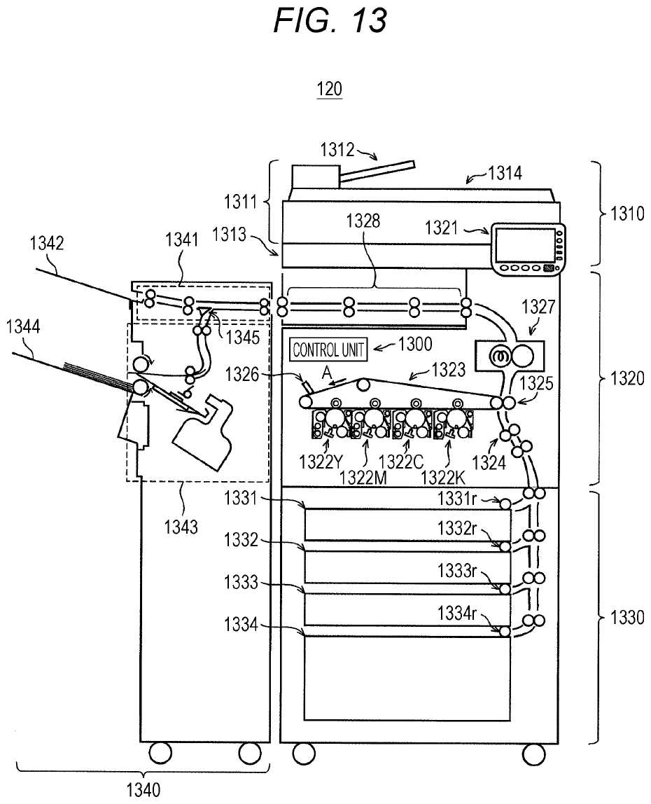

As illustrated in FIG. 13, the multi-function peripheral 120 includes a scanner device 1310, a printer device 1320, a paper feeder 1330, and a finisher 1340 and has a printer function, a scanner function, a copy function, a facsimile function, a document server function, and the like.

When receiving an instruction to read a document from the user via an operation panel 1321 provided in the printer device 1320, the scanner device 1310 uses an automatic document feeder (ADF) 1311 to feed documents one by one from a document stack placed on a document tray 1312 to an image reading unit 1313, uses the image reading unit 1313 to read the documents, and generate image data. The read documents are discharged onto a paper output tray 1314.

The printer device 1320 is a so-called tandem color printer and forms an image by an electrophotographic method. The printer device 1320 includes a control unit 1300, the control unit 1300 receives a normal operation command, a pre-operation command, or an additional operation command from the virtual assistant server 110 via the communication network 150 or receives a print job for which a user's instruction is input from the operation panel 1321.

When forming a monochrome image, the printer device 1320 having received a print job from the control unit 1300 forms a K-color toner image by using only an image forming unit 1322K and electrostatically transfers the image on an intermediate transfer belt 1323 (primary transfer). Furthermore, when forming a color image, toner images of YMCK colors are formed by using image forming units 1322Y, 1322M, and 1322C and the image forming unit 1322K, and these toner images are electrostatically transferred onto the intermediate transfer belt 1323 so that these toner images are superimposed on each other (primary transfer). This will form a color toner image.

The intermediate transfer belt 1323 is stretched around a secondary transfer roller pair 1325, a driven roller, and a tension roller and rotatably travels by rotation drive of the secondary transfer roller pair 1325 in a direction indicated by an arrow A. The intermediate transfer belt 1323 transports the toner image to the secondary transfer roller pair 1325 by the rotatable travel.

The paper feeder 1330 delivers recording sheets one by one by using pickup rollers 1331r, 1332r, 1333r, and 1334r, and the recording sheets are stored in a paper feed tray according to a paper type for which an instruction is given in a print job, of paper feed trays 1331, 1332, 1333, and 1334 Each of the delivered recording sheets is transported by a transport roller, corrected in skew and adjusted in transport timing by a timing roller 1324, and then transported up to the secondary transfer roller pair 1325.

A secondary transfer bias voltage is applied to the secondary transfer roller pair 1325, and whereby the toner image on the intermediate transfer belt 1323 is electrostatically transferred (secondary transfer) to the recording sheet. Toner remaining on the intermediate transfer belt 1323 after the secondary transfer is scraped off by a cleaning blade 1326 and discharged. After the toner image is thermally fused by a fuser 1327, the recording sheet is transported toward the finisher 1340 through a transport path 1328.

The fuser 1327 passes the recording sheet through a high-temperature fusing nip to thermally fuse the toner image. Therefore, the fuser 1327 needs to raise the temperature of the fusing nip (fusing temperature) to a predetermined target temperature prior to thermal fusing. This temperature rise processing is called warm-up. The fuser 1327 changes the target temperature of warm-up according to the resolution of a toner image and achieves high toner fixability and image quality.

The finisher 1340 controls the attitude of a path switching claw 1345 depending on whether an instruction given to perform post-processing in the print job. When no instruction is given to perform the post-processing, the recording sheet is guided to the paper output tray 1342 by the path switching claw 1345 through a transport path 1341. When an instruction is given to perform the post-processing, the path switching claw 1345 guides the recording sheet to a post-processing device 1343.

The post-processing device 1343 performs post-processing, such as alignment of, punching, stapling, and folding on recording sheets of a stack, in response to an instruction in the print job. The recording sheets subjected to the post-processing are discharged onto a paper output tray 1344.

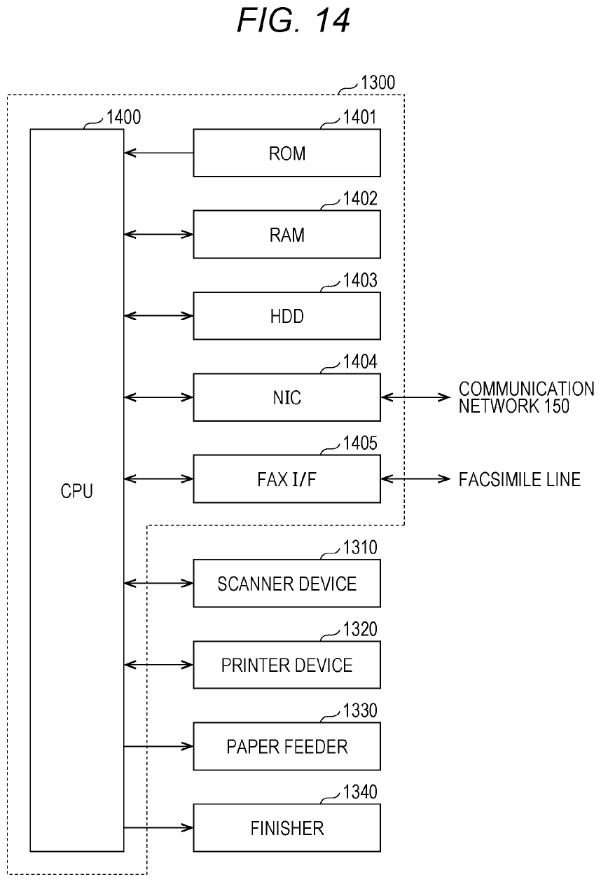

As illustrated in FIG. 14, the control unit 1300 includes a CPU 1400, a ROM 1401, a RAM 1402, and the like. When the multi-function peripheral 120 is powered on, the CPU 1400 is once reset and then reads a boot program from the ROM 1401 and activated, and reads and executes an OS, a monitoring control program, and the like from an HDD 1403, with the RAM 1402 as a work storage area. Therefore, the control unit 1300 monitors and controls the operations of the scanner device 1310, the printer device 1320, the paper feeder 1330, and the finisher 1340.

The NIC 1404 performs communication processing for interconnecting the virtual assistant server 110, the mobile terminal device 130, and the PC 140 to each other via the communication network 150. A facsimile interface 1405 performs communication processing for transmitting/receiving facsimile data to/from another facsimile device via a facsimile line.

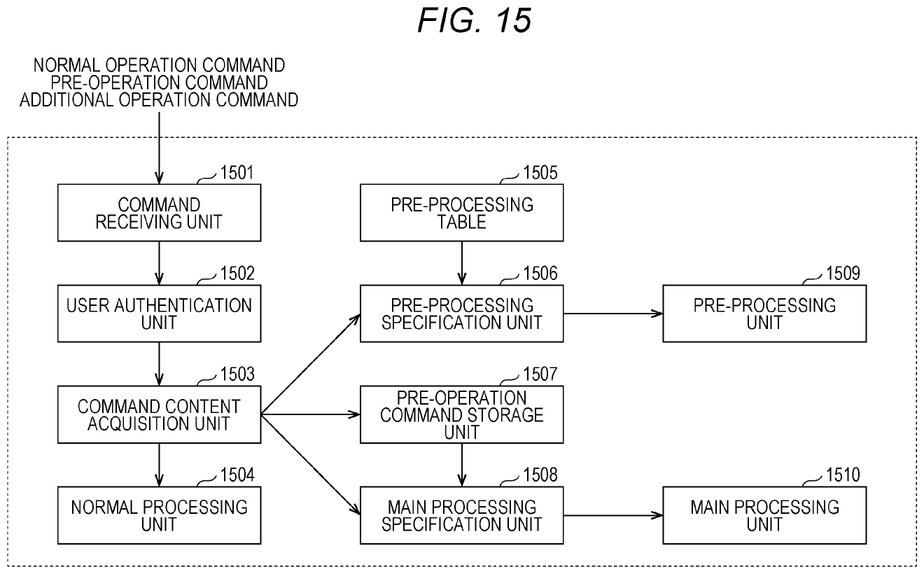

FIG. 15 is a block diagram illustrating a main functional configuration of the multi-function peripheral 120. As illustrated in FIG. 15, the multi-function peripheral 120 includes a command receiving unit 1501, a user authentication unit 1502, a command content acquisition unit 1503, and the like.

The command receiving unit 1501 receives a normal operation command, a pre-operation command, and an additional operation command from the virtual assistant server 110.

The user authentication unit 1502 performs authentication processing with reference to user identification information included in the operation command

When the user authentication is successful in the user authentication unit 1502, the command content acquisition unit 1503 acquires a command content included in the command received by the command receiving unit 1501.

When the operation command received by the command receiving unit 1501 is a normal operation command, a normal processing unit 1504 performs normal processing indicated by a command content acquired by the command content acquisition unit 1503.

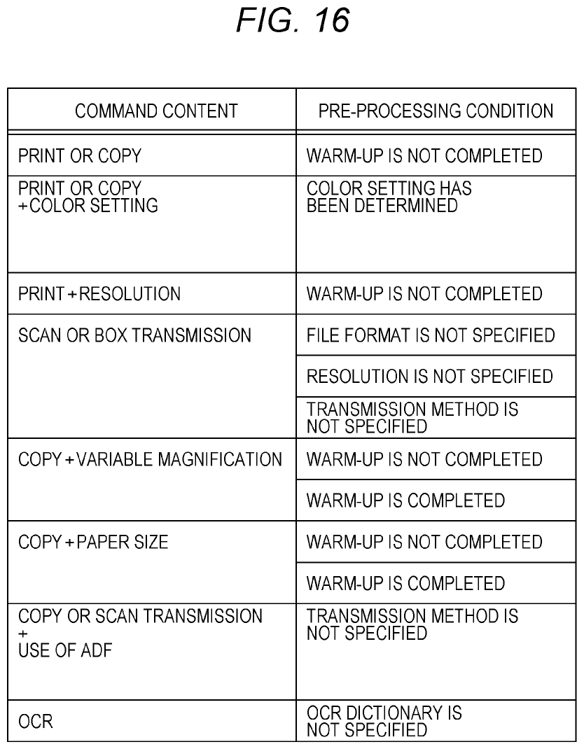

A pre-processing table 1505 stores a command content of a pre-operation command, a pre-processing condition for determining whether to perform pre-processing, and the pre-processing, in association with each other. As illustrated in FIG. 16, in the pre-processing table 1505, pre-processing conditions and pre-processing are stored for each command content.

For example, when the command contents of a pre-operation command represent print and the completion of warm-up of the multi-function peripheral 120, the warm-up is performed as the pre-processing. Furthermore, when the command contents of the pre-operation command represent print with specified resolution and the completion of warm-up of the multi-function peripheral 120, the warm-up is performed according to the resolution, as the pre-processing.

A pre-processing specification unit 1506 refers to the pre-processing table 1505, and when in the pre-processing table 1505, there is a cell in a column corresponding to command content of a pre-operation command acquired by the command content acquisition unit 1503 and the cell is filled with a pre-processing condition, the pre-processing specification unit 1506 specifies pre-processing corresponding to the cell.

A pre-processing unit 1509 performs the pre-processing specified by the pre-processing specification unit 1506. For example, the pre-processing unit 1509 performs, as the pre-processing, warm-up of the fuser 1327 or converts a file format or resolution of image data read and generated from a document by the scanner device 1310.

Examples of the file format of image data include Portable Document Format (PDF), Joint Photographic Experts Group (JPEG), Tagged Image File Format (TIFF), bitmap format, and the like. Furthermore, the resolution is, for example, 600 dpi (dot per inch), 400 dpi, 300 dpi, and 200 dpi.

Furthermore, as the pre-processing can also include communication settings for performing scan transmission and box transmission. Examples of communication for which communication settings are allowed include Server Message Block (SMB), electronic mail, file transfer protocol (FTP), facsimile and the like.

When OCR processing is performed as the pre-processing, examples of a dictionary used for the OCR processing can include Japanese, English, and Chinese dictionaries.

A pre-operation command storage unit 1507 stores a command content of a pre-operation command acquired by the command content acquisition unit 1503.

A main processing specification unit 1508 specifies main processing indicated by a command content being a combination of a command content of an additional operation command obtained by the command content acquisition unit 1503 and a command content of a pre-operation command stored in the pre-operation command storage unit 1507.

The main processing unit 1510 performs main processing specified by the main processing specification unit 1508.

### (5-2) Operation of Multi-Function Peripheral 120

Next, the operation of the multi-function peripheral 120 will be described.

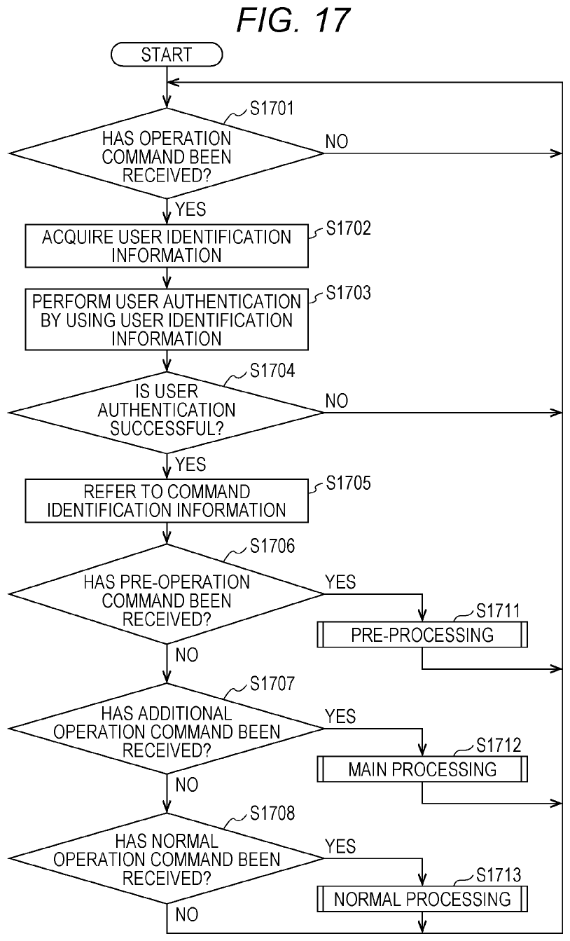

As illustrated in FIG. 17, when the multi-function peripheral 120 receives an operation command at the command receiving unit 1501 (S1701: YES), the user authentication unit 1502 acquires user identification information included in the operation command (S1702) and uses the acquired user identification information to perform user authentication (S1703). When the user authentication has failed (S1704: NO), the process proceeds to step S1701, and the process described above is repeated. When the user authentication is successful (S1704: YES), command identification information included in the operation command is referred to (S1705).

When the command identification information indicates a pre-operation command (S1706: YES), pre-processing is performed (S1711). When the command identification information indicates an additional operation command (S1707: YES), main processing is performed (S1712). Furthermore, when the command identification information indicates a normal operation command (S1708: YES), normal processing is performed (S1713). After the processing of steps S1711, S1712, and S1713, the process proceeds to step S1701, and the process described above is repeated.

### (5-2-1) Pre-Processing (S1711)

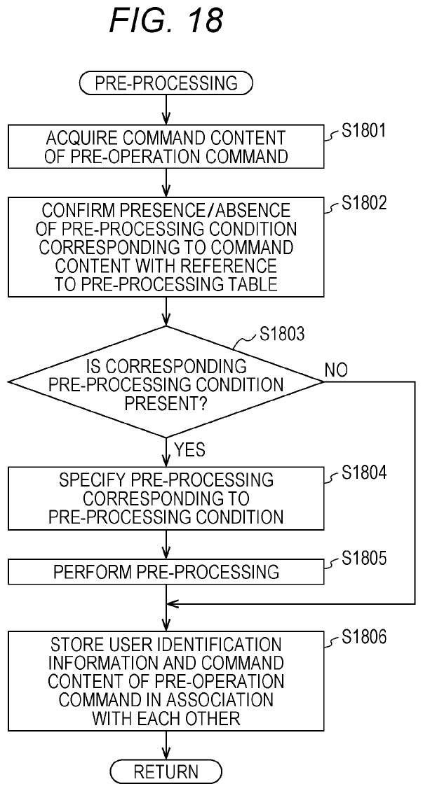

In the pre-processing, as illustrated in FIG. 18, firstly, the command content acquisition unit 1503 acquires a command content of a pre-operation command (S1801), and the pre-processing specification unit 1506 refers to the pre-processing table 1505 and confirms whether a pre-processing conditions corresponding to the command content is stored (S1802). When the corresponding pre-processing condition is stored in the pre-processing table 1505 (S1803: YES), pre-processing corresponding to the pre-processing condition is specified in the pre-processing table 1505 (S1804), and the specified pre-processing is performed (S1805).

When no pre-processing condition corresponding to the command content of the pre-operation command is stored in the pre-processing table (S1803: NO), after the processing of step S1805, the pre-operation command storage unit 1507 stores user identification information relating to the pre-operation command and the command content, in association with each other (S1806), and the process returns to an upper routine.

### (5-2-2) Main Processing (S1712)

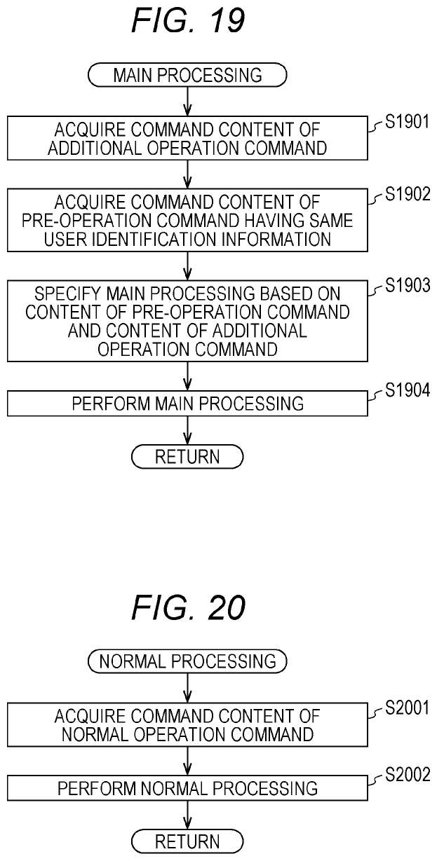

In the main processing, as illustrated in FIG. 19, firstly, the command content acquisition unit 1503 acquires a command content of an additional operation command (S1901), and the pre-operation command storage unit 1507 specifies a command content stored in association with user identification information relating to the additional operation command (S1902). Then, the main processing specification unit 1508 specifies the main processing from the command content relating to the additional operation command and the command content relating to the pre-operation command corresponding to the additional operation command (S1903), the main processing unit 1510 performs the main processing (S1904), and then the process returns to the upper routine.

### (5-2-3) Normal Processing (S1713)

In the normal processing, as illustrated in FIG. 20, after the command content acquisition unit 1503 acquires a command content of a normal operation command (S2001), the normal processing unit 1504 performs normal processing indicated by the command content (S2002), and then the process returns to the upper routine.

### (5-3) Specific Examples of Pre-Processing

Specific examples of the pre-processing will be described.

### (5-3-1) Specific Example 1

If a command content of a pre-operation command includes the word “print” or “copy”, the multi-function peripheral 120 refers to the pre-processing table 1505 to search for a cell in a column of command content filled with “print or copy” and refers to a cell in a column of pre-processing condition corresponding to the cell. In the example of FIG. 16, the cell in the column of pre-processing condition is filled with “Warm-up is not completed”, and the multi-function peripheral 120 refers to the fusing temperature of the fuser 1327 and confirms whether the predetermined target temperature is achieved.

If the warm-up has not been completed, “warm-up” filled in a cell in a column of pre-processing is performed as the pre-processing. This configuration can reduce a first copy out time (FCOT) in printing and copying, compared with a case where warm-up is started in response to reception of an additional operation command, improving user convenience.

In addition, if the warm-up is completed, pre-processing is unnecessary.

For example, in a case where the user's instruction is “Print this Word file in 2in1 mode on both sides of an A4 recycled paper using a nearby MFP” and the virtual assistant server 110 fails to recognize only a portion “on both sides” in voice recognition, if the smart speaker 100 returns “I did not catch that. Could you say that again?” to request the user to input the user's instruction again, and then the multi-function peripheral 120 starts printing after the user instruction is input again, start of a print job is delayed.

On the other hand, as described above, the smart speaker 100 is used to request the user to give a repeated instruction, after replacing a portion where voice recognition has failed with a warning sound, for example, “The condition is 2in1 mode, BEEP, A4 recycled paper. Is that satisfactory?” In parallel with this, if a pre-operation command is transmitted to the multi-function peripheral 120 so as to perform warm-up as the pre-processing by using a portion for which voice recognition is successful, that is, “Print this Word file in 2in1 mode on A4 recycled paper using a nearby MFP”, a print job having an instruction content determined by the repeated instruction can be started quickly.

### (5-3-2) Specific Example 2

If a command content of a pre-operation command includes the word “print” or “copy” and a word for color setting, the pre-processing table 1505 is referred to, a cell in the column of command content filled with “print or copy+color setting” is searched for, and a cell in the column of pre-processing condition corresponding to the cell is referred to. In the example of FIG. 16, since “color setting has been determined” is filled in the cell in the column of pre-processing condition, it is confirmed whether the color setting has been determined in the command content of the pre-operation command

When the color setting has been determined, preparation for supplying toner used for color setting for any of color, two-color, and monochrome is executed.

This configuration can quickly complete printing and copying, compared with a case where preparation for supplying toner is started in response to reception of an additional operation command, improving user convenience.

### (5-3-3) Specific Example 3

If a command content of a pre-operation command includes the word “print” and a word specifying resolution, a cell in the column of pre-processing condition corresponding to a cell filled with “print+resolution” is referred to. In the example of FIG. 16, the cell in the column of pre-processing condition is filled with “Warm-up is not completed”, and the multi-function peripheral 120 refers to the fusing temperature of the fuser 1327 and confirms whether the predetermined target temperature is achieved.

If the warm-up has not been completed, “warm-up according to resolution” filled in a cell in the column of pre-processing is performed as the pre-processing. Here, the warm-up according to the resolution means that the warm-up is performed so that the temperature of the fuser has a fusing temperature corresponding to the resolution. This configuration can reduce the FCOT, compared with a case where warm-up is started in response to reception of an additional operation command

In addition, if the warm-up is completed, pre-processing is unnecessary.

### (5-3-4) Specific Example 4

If a command content of a pre-operation command includes the word “scan” or “box transmission”, a cell filled with “scan or box transmission” has three corresponding cells in the column of pre-processing condition, and the three pre-processing conditions are referred to in order. As the first pre-processing condition, it is confirmed whether a word specifying a file format is included in the pre-operation command (FIG. 16).

If no word specifying a file format is included, “conversion to all available file formats” filled in a cell in the column of pre-processing is performed as the pre-processing. All available file formats means all file formats that can be generated by the multi-function peripheral 120, such as PDF, JPEG, TIFF, and a bitmap format.

This configuration only requires selection of a file having a file format specified in an additional operation command after receiving the additional operation command, and thus the scanning or box transmission is completed quickly, compared with a case where the file format is converted in response to reception of an additional operation command

Note that in a case where the file format is specified in the pre-operation command, the file format is immediately converted to the specified file format.

### (5-3-5) Specific Example 5

If a command content of a pre-operation command includes the word “scan” or “box transmission”, the second cell in the column of pre-processing condition corresponding to the cell filled with “scan or box transmission” is also referred to, and whether a word specifying resolution is included in the pre-operation command is confirmed (FIG. 16).

If no word specifying resolution is included, “conversion to all available resolutions” filled in a cell in the column of pre-processing is performed as the pre-processing. All available resolutions means all of the resolutions that can be generated by the multi-function peripheral 120, such as 600 dpi, 400 dpi, 300 dpi, and 200 dpi.

This configuration only requires selection of a file having a resolution specified in an additional operation command after receiving the additional operation command, and thus the scanning or box transmission is completed quickly, compared with a case where the resolution is converted in response to reception of an additional operation command

Note that in a case where the resolution is specified in the pre-operation command, the resolution is immediately converted to the specified resolution.

### (5-3-6) Specific Example 6

If a command content of a pre-operation command includes the word “scan” or “box transmission”, the third cell in the column of pre-processing condition corresponding to the cell filled with “scan or box transmission” is also referred to, and whether a word specifying a transmission method is included in the pre-operation command is confirmed (FIG. 16).

If no word specifying a transmission method is included, “setting communication by all available transmission methods” filled in a cell in the column of pre-processing is performed as the pre-processing. All available transmission methods means all transmission methods that can be performed by the multi-function peripheral 120, such as SMB, electronic mail, FTP, and facsimile. The communication setting includes, for example, processing for securing resources necessary for starting communication, establishment of a connection or session, and the like.

This configuration enables to start transmission quickly upon receiving the additional operation command, and thus the scanning or box transmission is completed quickly, compared with a case where communication setting is performed after receiving the additional operation command

Note that in a case where the transmission method is specified in the pre-operation command, the communication is set only for the specified transmission method.

For example, in a case where the user's instruction is “Make a CompactPDF file of scanned files and send it to a PC using SMB” and the virtual assistant server 110 cannot recognize only a portion “SMB”, if the smart speaker 100 returns “I did not catch that. Could you say that again?” to request the user to input the user's instruction again, and then the multi-function peripheral 120 starts scanning after the user instruction is input again, completion of a scan transmission job is delayed.

On the other hand, as described above, the smart speaker 100 is used to request the user to give a repeated instruction, for example, either “Which transmission method would you like to select?” or “Would you like to select BEEP?” after replacing a portion where voice recognition has failed with a warning sound. In parallel with this, if a pre-operation command is transmitted to the multi-function peripheral 120 so as to perform communication setting as the pre-processing by using a portion for which voice recognition is successful, that is, “Make a CompactPDF file of scanned files and send it to a PC”, the scan transmission job having an instruction content determined by the repeated instruction can be completed quickly.

### (5-3-7) Specific Example 7

If a command content of a pre-operation command includes the word “copy” and a word specifying variable magnification, a cell filled with “copy+variable magnification” has two corresponding cells in the column of pre-processing condition, and the two pre-processing conditions are referred to in order. As a first pre-processing condition, the fusing temperature of the fuser 1327 is referred to and whether the predetermined target temperature is achieved is confirmed (FIG. 16).

If the fusing temperature does not reach a predetermined target temperature and the warm-up is therefore not completed, “warm-up+variable magnification processing” filled in a cell in the column of pre-processing is performed as the pre-processing. The warm-up is processing for raising the temperature of the fuser 1327 to the predetermined target temperature, and the variable magnification processing is processing for variably magnifying image data at a specified variable magnification.

Furthermore, if the fusing temperature reaches the predetermined target temperature and warm-up has been completed, corresponding to the two pre-processing conditions, only the variable magnification processing is performed, as shown in a cell in the column of pre-processing.

This configuration can complete copying earlier, compared with a case where warm-up and variable magnification processing are performed in response to reception of an additional operation command

### (5-3-8) Specific Example 8

If a command content of a pre-operation command includes the word “copy” and a word specifying paper size, a cell filled with “copy+paper size” has two corresponding cells in the column of pre-processing condition, and the two pre-processing conditions are referred to in order. As a first pre-processing condition, the fusing temperature of the fuser 1327 is referred to and whether the predetermined target temperature is achieved is confirmed (FIG. 16).

If the fusing temperature does not reach a predetermined target temperature and the warm-up is therefore not completed, “warm-up+paper standby” filled in a cell in the column of pre-processing is performed as the pre-processing. The warm-up is processing for raising the temperature of the fuser 1327 to a predetermined target temperature, and the paper standby is a state in which transport of paper sheet of a specified size is started and an end of the paper sheet abuts on the timing roller 1324.

Furthermore, if the fusing temperature reaches the predetermined target temperature and warm-up has been completed, corresponding to the two pre-processing conditions, only paper standby is performed, as shown in a cell in the column of pre-processing.

This configuration can complete copying earlier, compared with a case where warm-up and paper transport are performed in response to reception of an additional operation command

### (5-3-9) Specific Example 9

If a command content of a pre-operation command includes the word “copy” or “scan transmission” and a word specifying use of the automatic document feeder 1311, a cell in the column of pre-processing condition corresponding to a cell filled with “copy or scan transmission+use of ADF” is referred to, and whether a transmission method is specified in the command content of the pre-operation command is confirmed (FIG. 16).

When no transmission method is specified, the automatic document feeder 1331 is used to read both sides of the document, and communication settings are performed for all available transmission methods.

This configuration can complete copying and scan transmission earlier, compared with a case where reading document and communication setting are started in response to reception of an additional operation command

Note that examples of the transmission methods used for scan transmission include, for example, box transmission, facsimile transmission, SMB, FTP, and electronic mail.

### (5-3-10) Specific Example 10

If a command content of a pre-operation command includes the word “OCR”, a cell in the column of pre-processing condition corresponding to a cell filled with “OCR” is referred to, and whether a dictionary used for OCR is specified in the pre-operation command is confirmed (FIG. 16).

If no dictionary is specified, OCR processing is performed for each dictionary, for all dictionaries that are available by the multi-function peripheral 120. Examples of the dictionaries that the multi-function peripheral 120 is available include Japanese, English, and Chinese dictionaries.

This configuration can complete OCR earlier, compared with a case where OCR processing is performed using a dictionary specified in a command content of an additional operation command in response to reception of an additional operation command

### [6] Configuration and Operation of Mobile Terminal Device 130

Next, the configuration and operation of the mobile terminal device 130 will be described.

### (6-1) Configuration of Mobile Terminal Device 130

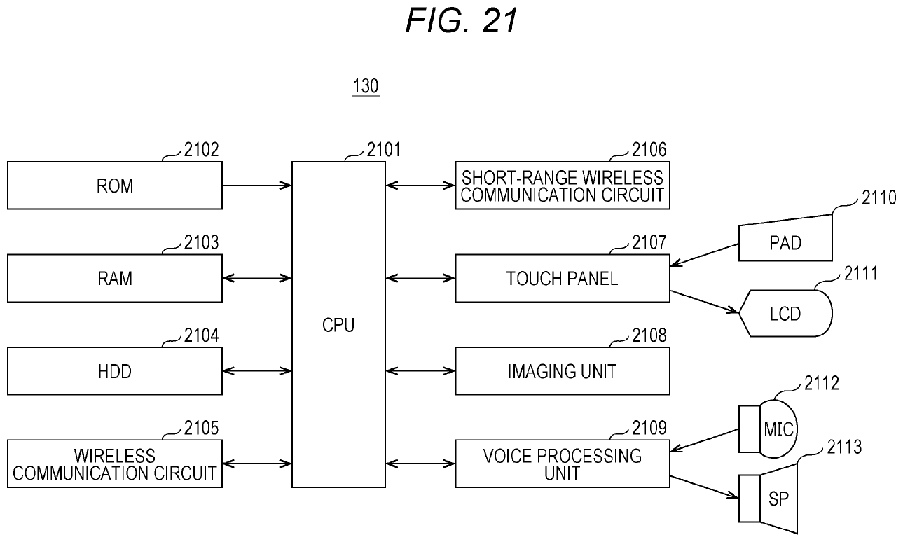

As illustrated in FIG. 21, the mobile terminal device 130 includes a CPU 2101, a ROM 2102, a RAM 2103, and the like. When the CPU 2101 is reset, a boot program is read from the ROM 2102 for activation, and an OS and application programs read from the HDD 2104 are executed with the RAM 2103 as a working storage area. The application programs include a printer driver for using the multi-function peripheral 120.

A wireless communication circuit 2105 performs processing for wireless communication with a public network (not illustrated), and a short-range wireless communication circuit 2106 performs communication processing for interconnection with the multi-function peripheral 120 via the wireless LAN router 160 and the communication network 150. A touch panel 2107 includes a touch pad 2110 and a liquid crystal display (LCD) 2111, and the touch panel 2107 presents information to the user and receives an instruction input from the user.

The imaging unit 2108 is a so-called camera and performs processing for capturing a still image or a moving image. A voice processing unit 2109 includes a microphone 2112 and a speaker 2113. The microphone 2112 is used to generate an analog voice signal from the voice of a user's instruction or repeated instruction, and further, convert the analog voice signal into a digital voice signal and convert the digital voice signal into an analog voice signal. Then, the speaker 2113 is used to output voice using the analog voice signal.

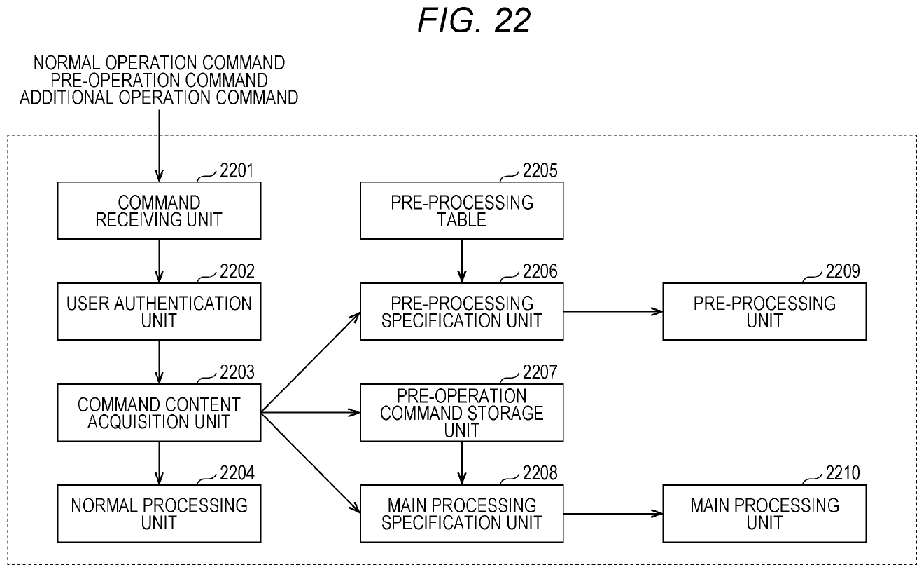

As illustrated in FIG. 22, the mobile terminal device 130 executes an application program to function as a command receiving unit 2201, a user authentication unit 2202, a command content acquisition unit 2203, and the like, as in the multi-function peripheral 120.

The command receiving unit 2201 receives a normal operation command, a pre-operation command, and an additional operation command from the virtual assistant server 110. The user authentication unit 2202 performs authentication processing with reference to user identification information included in the operation command

When the user authentication is successful in the user authentication unit 2202, the command content acquisition unit 2203 acquires a command content included in the command received by the command receiving unit 2201. When the operation command received by the command receiving unit 2201 is a normal operation command, a normal processing unit 2204 performs normal processing indicated by a command content acquired by the command content acquisition unit 2203.

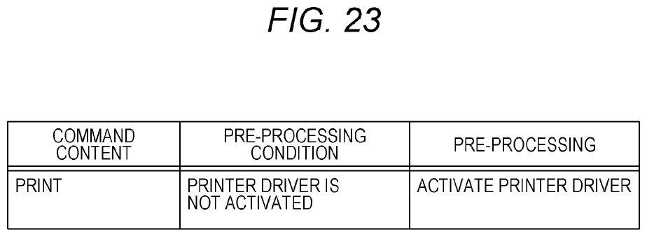

A pre-processing table 2205 stores a command content of a pre-operation command, a pre-processing condition for determining whether to perform pre-processing, and the pre-processing, in association with each other. As illustrated in FIG. 23, in the pre-processing table 2205, pre-processing conditions and pre-processing are stored for each command content.

For example, when the command contents of a pre-operation command represent print and the completion of warm-up of the mobile terminal device 130, the warm-up is performed as the pre-processing. Furthermore, when the command contents of the pre-operation command represent print with specified resolution and the completion of warm-up of the mobile terminal device 130, the warm-up is performed according to the resolution, as the pre-processing.

A pre-processing specification unit 2206 refers to the pre-processing table 2205, and when in the pre-processing table 2205, there is a cell in a column corresponding to command content of a pre-operation command acquired by the command content acquisition unit 2203 and the cell is filled with a pre-processing condition, the pre-processing specification unit 2206 specifies pre-processing corresponding to the cell.

A pre-processing unit 2209 performs the pre-processing specified by the pre-processing specification unit 2206. A pre-operation command storage unit 2207 stores a command content of a pre-operation command acquired by the command content acquisition unit 2203.

A main processing specification unit 2208 specifies main processing indicated by a command content being a combination of a command content of an additional operation command obtained by the command content acquisition unit 2203 and a command content of a pre-operation command stored in the pre-operation command storage unit 2207. The main processing unit 2210 performs main processing specified by the main processing specification unit 2208.

### (6-2) Operation of Mobile Terminal Device 130

Next, the operation of the mobile terminal device 130 will be described.

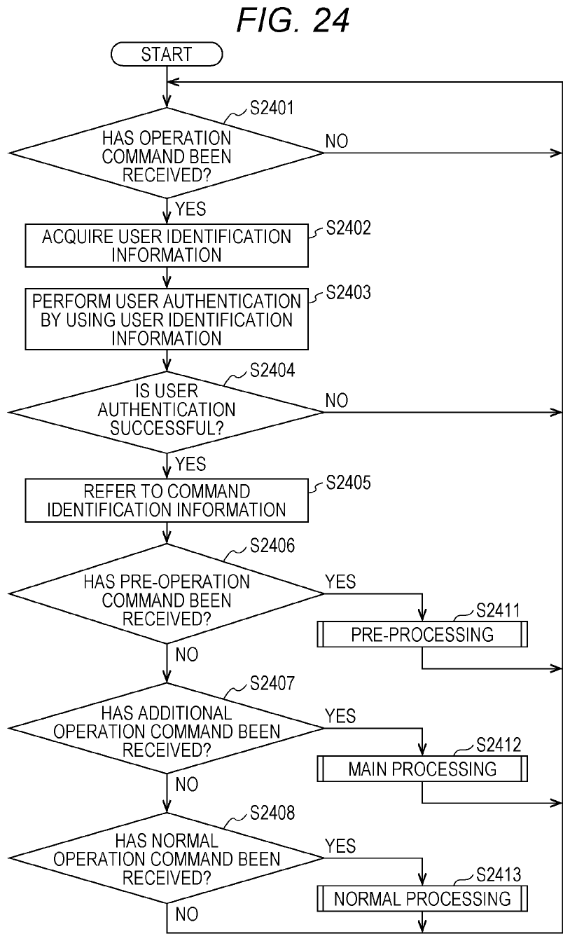

As illustrated in FIG. 24, when the mobile terminal device 130 receives an operation command at the command receiving unit 2201 (S2401: YES), the user authentication unit 2202 acquires user identification information included in the operation command (S2402) and uses the acquired user identification information to perform user authentication (S2403), as in the multi-function peripheral 120. When the user authentication fails (S2404: NO), the process proceeds to step S2401, and the process described above is repeated. When the user authentication is successful (S2404: YES), command identification information included in the operation command is referred to (S2405).

When the command identification information indicates a pre-operation command (S2406: YES), pre-processing is performed (S2411). When the command identification information indicates an additional operation command (S2407: YES), main processing is performed which is specified from a command content of the pre-operation command and a command content of the additional operation command (S2412). When the command identification information indicates a normal operation command (S2408: YES), normal processing is performed (S2413). After the processing of steps S2411, S2412 and S2413, the process proceeds to step S2401, and the process described above is repeated.

### (6-2-1) Pre-Processing (S2411)

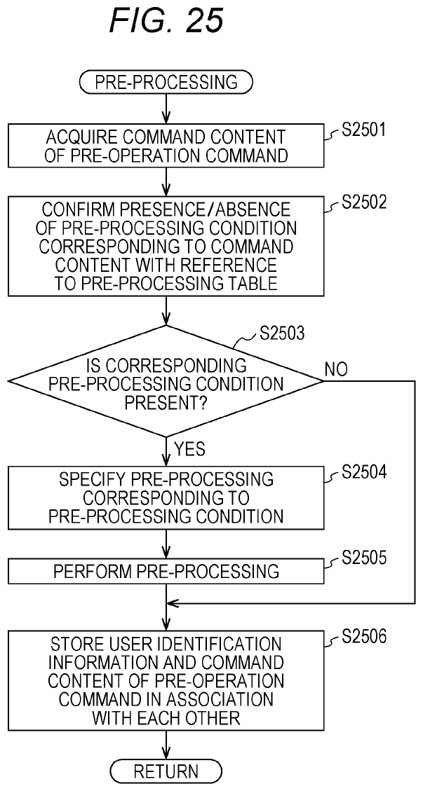

In the pre-processing, as illustrated in FIG. 25, firstly, the command content of the pre-operation command is acquired by the command content acquisition unit 2203 (S2501). Next, the pre-processing specification unit 2206 refers to the pre-processing table 2205 and confirms whether a pre-processing condition corresponding to the command content is stored (S2502). When the corresponding pre-processing condition is stored in the pre-processing table 2205 (S2503: YES), pre-processing corresponding to the pre-processing condition is specified in the pre-processing table 2205 (S2504), and the specified pre-processing is performed (S2505).

When no pre-processing condition corresponding to the command content of the pre-operation command is stored in the pre-processing table (S2503: NO), after the processing of step S2505, the pre-operation command storage unit 2207 stores user identification information relating to the pre-operation command and the command content, in association with each other (S2506), and the process returns to an upper routine.

### (6-2-2) Main Processing (S2412)

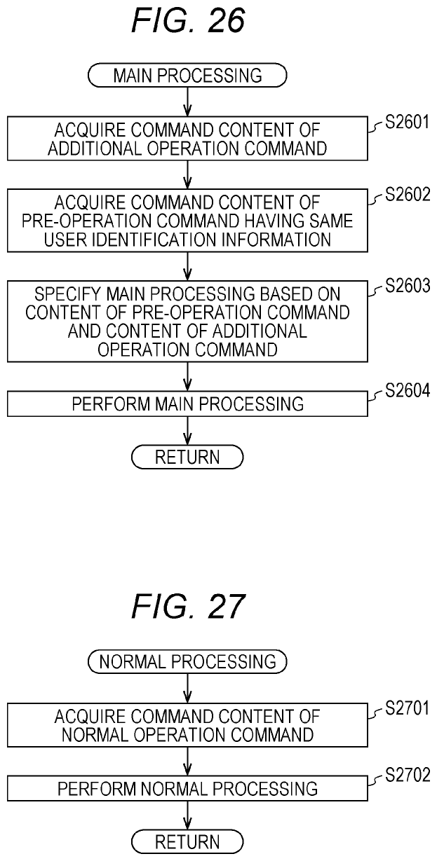

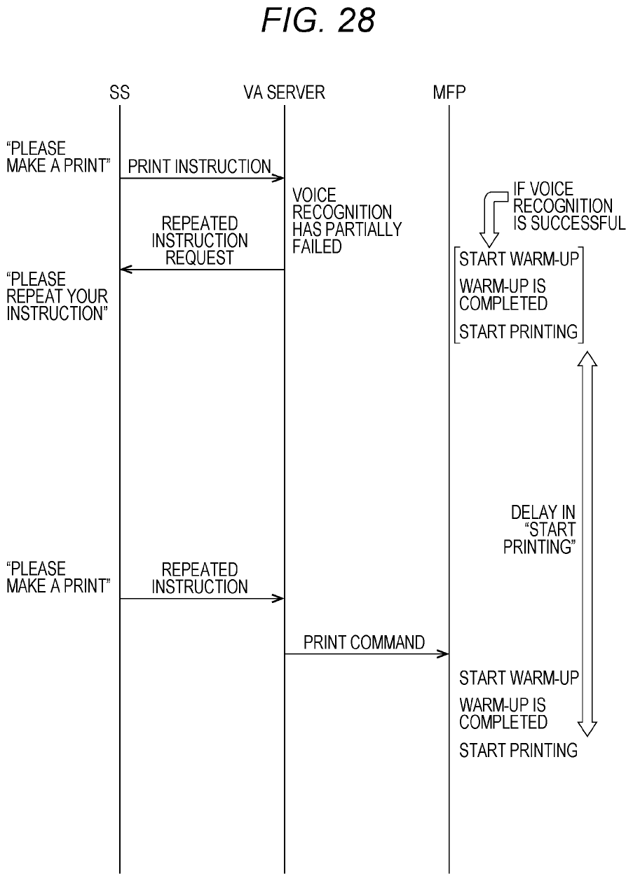

In the main processing, as illustrated in FIG. 26, firstly, the command content of the additional operation command is acquired by the command content acquisition unit 2203 (S2601). Next, the pre-operation command storage unit 2207 specifies a command content stored in association with user identification information relating to the additional operation command (S2602). Then, the main processing specification unit 2208 specifies the main processing from the command content relating to the additional operation command and the command content relating to the pre-operation command corresponding to the additional operation command (S2603), the main processing unit 2210 performs the main processing (S2604), and then the process returns to the upper routine.

### (6-2-3) Normal Processing (S2413)

In the normal processing, as illustrated in FIG. 27, the command content acquisition unit 2203 acquires a command content of a normal operation command (S2701), the normal processing unit 2204 performs normal processing indicated by the command content (S2702), and then the process returns to the upper routine.

### (6-3) Specific Examples of Pre-Processing

Specific examples of the pre-processing will be described.

If a command content of a pre-operation command includes the word “print”, the mobile terminal device 130 refers to the pre-processing table 2205 to search for a cell in a column of command content filled with “print” and refers to a cell in a column of pre-processing condition corresponding to the cell. In the example of FIG. 23, the cell in a column of pre-processing condition is filled with “printer driver is not activated”, and the mobile terminal device 130 confirms whether the printer driver is activated.

If the printer driver is not activated, “activate printer driver” filled in a cell in a column of pre-processing is performed as pre-processing. This configuration enables the user of the mobile terminal device 130 to operate the printer driver without waiting for activation of the printer driver, compared with a case where the printer driver is activated in response to reception of an additional operation command Thus, the reduction of the waiting time of the user can improve user convenience.

If the printer driver has already been activated, the printer driver does not need to be activated as the pre-processing.

### [7]<Modifications>

As described above, the present invention has been described according to the embodiments, but as a matter of course the present invention is not limited to the above embodiments, and the following modifications can be made.

(7-1) In the above embodiment, an example of a repeated instruction requested when voice recognition of a user's instruction has partially failed has been described, but it is regardless to say that the present invention is not limited to this description and may be configured as follows.

For example, in a case where voice recognition of a user's instruction has partially failed, the virtual assistant server 110 confirms a pre-processing condition, and when the multi-function peripheral 120 or the like cannot perform pre-processing, the smart speaker 100 is used to make a request to input the entire user's instruction again by outputting a voice message “I did not catch that. Could you say that again?”.

As described above, even if the virtual assistant server 110 transmits a pre-operation command to the multi-function peripheral 120 or the like which is configured to perform pre-processing only when the pre-processing is performed in the multi-function peripheral 120 or the like, similar effects to those in the above embodiments can be obtained.

Note that whether the multi-function peripheral 120 or the like can perform the pre-processing may be performed by transmitting a user instruction acceptance incomplete notification including text data of a portion of the user's instruction for which voice recognition is successful to the multi-function peripheral 120 or the like and causing the multi-function peripheral 120 or the like to confirm the pre-processing condition and return a confirmation result, when the virtual assistant server 110 has partially failed in voice recognition of the user's instruction.

(7-2) In the above embodiments, an example of use of the virtual assistant server 110 has been described, but, as a matter of course, the present invention is not limited to this description, and processing may be performed by transmitting/receiving voice data between the smart speaker 100 and the multi-function peripheral 120 without passing through the virtual assistant server 110.
(7-3) Although not particularly mentioned in the above embodiment, the multi-function peripheral 120 or the like may stand by in a waiting state, after completion of the pre-processing, until receiving an additional operation command corresponding to a pre-operation command relating to the pre-processing from the virtual assistant server 110. This waiting state is a state in which, for example, when the pre-processing is warm-up, the fusing temperature is maintained at a predetermined target temperature after the warm-up is completed. Furthermore, this waiting state may be a state in which files generated to have available formats or available resolutions is maintained without deleting.
(7-4) In the above embodiments, an example of the smart speaker 100 which uses GPS to detect the installation position has been described, but as a matter of course, the present invention is not limited to this description, and instead of this configuration, a smart speaker 100 may be identified by information other than position information, such as a serial number of the smart speaker 100, and a nearby multi-function peripheral 120 may be specified for each smart speaker 100 with reference to a correspondence table indicating correspondence between individual smart speakers 100 and the multi-function peripherals 120.
(7-5) In the above embodiments, an example of the printer device 1320 included in the multi-function peripheral 120 and being a tandem color printer has been described, but as a matter of course, the present invention is not limited to this description, and the printer device 1320 may be a color printer other than the tandem color printer or may be a monochrome printer. Furthermore, the printer device 1329 may adopt an ink jet printer other than an electrophotographic printer.

In addition, application of the present invention will provide the same effects, regardless of the function of the multi-function peripheral 120.

The voice operation system, the voice operation method, and the voice operation program according to the present invention are useful as a technology that can suppress the start delay of device operation when a voice instruction needs to be given again.

Although embodiments of the present invention have been described and illustrated in detail, the disclosed embodiments are made for purposes of illustration and example only and not limitation. The scope of the present invention should be interpreted by terms of the appended claims.

What is claimed is:

1. A voice operation system comprising:
a processing device; and
a receiver that receives a user's voice instruction given to the processing device, wherein
the receiver includes:
a voice recognizer that performs voice recognition of the voice instruction; and
a notifier that, when the voice recognizer has partially failed in voice recognition of a portion of the voice instruction, notifies the processing device of an operation command corresponding to the portion of the voice instruction for which voice recognition has been successful, and
the processing device includes
a processor that performs processing corresponding to a command content of the operation command.

2. The voice operation system according to claim 1, wherein
the processing device includes:
a storage that stores the command content of the operation command, pre-processing corresponding to the command content, and a pre-processing condition for performance of the pre-processing, in association with each other; and
a processing specifier that, when a pre-processing condition associated with a notified operation command is satisfied, specifies a pre-processing associated with the operation command, and
the processor performs the pre-processing specified by the processing specifier, as the processing.

3. The voice operation system according to claim 2, wherein
the receiver further includes:
a repeated instruction acceptor that, when the voice recognizer has partially failed in voice recognition of the voice instruction, accepts a repeated instruction for the failed portion; and
an addition notifier that notifies the processing device of a portion of the repeated instruction as an additional operation command, and
the processing device further includes
a main performer that performs main processing according to the operation command and the additional operation command, by using a result of the pre-processing.

4. The voice operation system according to claim 3, wherein
the receiver further includes:
a hardware processor that specifies a user by voice recognition; and
a user notifier that notifies the processing device of an specified user,
the notifier also notifying of a user specified from the voice instruction,
the addition notifier also notifying of a user specified from the repeated instruction,
the processing device further
performs a plurality of jobs associated with a user, and
includes a job specifier that specifies a job associated with the user who is notified of, and
the main performer performs a main processing according to an operation command and an additional operation command relating to the same user.

5. The voice operation system according to claim 3, wherein
the repeated instruction acceptor includes a repeated instruction requestor that requests for a repeated instruction by presenting a portion of the voice instruction where voice recognition has failed, and
the repeated instruction acceptor receives a user's response to the request as the repeated instruction.

6. The voice operation system according to claim 5, wherein
the repeated instruction requestor
outputs, by voice, a portion of the voice instruction where voice recognition has failed and outputs voice indicating partial failure of the voice recognition so as to request for a repeated instruction.

7. The voice operation system according to claim 5, wherein
the repeated instruction requestor
outputs voice in which a portion of the voice instruction where voice recognition has failed is replaced with a warning sound, and requests for a repeated instruction.

8. The voice operation system according to claim 2, wherein
the processing device is an image processor, and
in a case where the operation command is a command relating to a print operation,
the processing specifier confirms whether the image processor has completed warm-up processing, and
if the warm-up processing has not been completed, the processing specifier sets the pre-processing as warm-up processing.

9. The voice operation system according to claim 8, wherein
in a case where a resolution is specified in the operation command,
processing specifier sets the pre-processing as warm-up processing of warming up fusing temperature according to the resolution.

10. The voice operation system according to claim 2, wherein
the processing device is a terminal, and
in a case where the operation command is a command relating to a print operation,
the processing specifier sets the pre-processing as processing of activating a printer driver creating a print job with the terminal and of inputting a print condition specified in the operation command into the printer driver.

11. The voice operation system according to claim 2, wherein
the processing device is an image processor, and
in a case where the operation command is a command relating to file transmission of image data read from a document by the image processor or image data stored in advance,
the processing specifier sets the pre-processing as processing of creating files to be transmitted, in a plurality of available file formats.

12. The voice operation system according to claim 11, wherein
in a case where a resolution is specified in the operation command,
the processing specifier sets the pre-processing as processing of creating a file with the specified resolution.

13. The voice operation system according to claim 11, wherein
in a case where the image processor can transmit a file by a plurality of transmission methods,
the processing specifier includes, as the pre-processing, a communication setting process in each transmission method.

14. The voice operation system according to claim 2, wherein
the processing device is an image processor, and
in a case where the operation command is a command relating to a copy operation,
the processing specifier confirms whether the image processor has completed warm-up processing, and
if the warm-up processing has not been completed, the processing specifier sets the pre-processing as warm-up processing.

15. The voice operation system according to claim 14, wherein
in a case where a variable magnification of an image size to be input is specified in the pre-operation command,
the processing specifier includes, as the pre-processing, processing of reading a document to generate image data and variably changing obtained image data with the variable magnification.

16. The voice operation system according to claim 14, wherein
in a case where paper size is specified in the operation command,
the processing specifier includes, as the pre-processing, processing of transporting a sheet of a specified sheet size and causing the sheet to wait at a standby position upstream from a toner image transfer position in a direction of the transport.

17. The voice operation system according to claim 2, wherein
the processing device is an image processor, and
in a case where the operation command is a command that requires reading of a document with an automatic document feeder,
the processing specifier sets the pre-processing as processing for reading both sides of a document by using an automatic document feeder.

18. The voice operation system according to claim 2, wherein
the processing device is an image processor, and
in a case where the operation command is a command related to formation of a color image,
the processing specifier sets the pre-processing as processing of preparing supply of toner or ink corresponding to color setting.

19. The voice operation system according to claim 2, wherein
the processing device is an image processor, and
in a case where the operation command is a command relating to character recognition processing using any one of a plurality of dictionaries,
the processing specifier sets the pre-processing as processing of preparing a plurality of character recognition results by using the plurality of dictionaries, respectively.

20. The voice operation system according to claim 3, wherein
the main performer waits for performance of the main processing until an additional operation command is notified of from the receiver.

21. The voice operation system according to claim 1, further comprising
a plurality of processing devices, wherein
the receiver includes a device selector that specifies a position of the user and the processing device and selects a processing device having a minimum distance from the user, and
the notifier performs the notification to the processing device selected by the device selector.

22. The voice operation system according to claim 1, wherein
the receiver includes:
a smart speaker that accepts the voice instruction; and
a server having the voice recognizer and the notifier.

23. A voice operation method performed by a voice operation system including a processing device and a receiver that receives a user's voice instruction given to the processing device, the method comprising:
performing voice recognition of the voice instruction by the receiver;
notifying the processing device of an operation command corresponding to a portion of the user's instruction for which voice recognition is successful when voice recognition of the voice instruction has partially failed in the performing voice recognition; and
performing processing corresponding to a command content of the operation command.

24. The voice operation method according to claim 23, further comprising:
storing the command content of the operation command, pre-processing corresponding to the command content, and a pre-processing condition for performance of the pre-processing, in association with each other; and
specifying a pre-processing associated with the operation command, when a pre-processing condition associated with a notified operation command is satisfied, wherein
in the performing processing, the pre-processing specified in the specifying a pre-processing is performed as the processing.

25. The voice operation method according to claim 23, wherein
in a voice operation system including a plurality of processing devices,
the method further includes specifying a position of the user and the processing device and selecting a processing device having a minimum distance from the user, by the receiver, and
in the notifying, performing the notification to the processing device selected in the specifying a position of the user and the processing device.

26. A non-transitory recording medium storing a computer readable sound operation program causing a computer system including a processing device and a receiver that receives a user's voice instruction given to the processing device to execute:
performing voice recognition of the voice instruction by the receiver;
notifying the processing device of an operation command corresponding to a portion of the voice instruction for which voice recognition is successful, when voice recognition of the voice instruction has partially failed in the performing voice recognition; and
performing processing corresponding to a command content of the operation command.

27. The non-transitory recording medium storing a computer readable sound operation program according to claim 26, the program further causing the computer system to execute:
storing the command content of the operation command, pre-processing corresponding to the command content, and a pre-processing condition for performance of the pre-processing, in association with each other; and
specifying a pre-processing associated with the operation command, when a pre-processing condition associated with a notified operation command is satisfied, wherein
in the performing processing, the pre-processing specified in the specifying a pre-processing is performed as the processing.

28. The non-transitory recording medium storing a computer readable sound operation program according to claim 26, wherein
in a computer system including a plurality of processing devices,
the program further includes specifying a position of the user and the processing device and selecting a processing device having a minimum distance from the user, by the receiver, and
in the notifying, performing the notification to the processing device selected in the specifying a position of the user and the processing device.
